(19) United States
(12) Patent Application Publication
(10) Pub. No.: US 2012/0115380 A1
(43) Pub. Date: May 10, 2012

(54) CHANNEL AND WATER STORAGE LINER

(75) Inventor: Russell Hanna, Milsons Point (AU)

(73) Assignee: INFRASTRUCTURE TECHNOLOGIES LIMITED, Hong Kong (CN)

(21) Appl. No.: 13/266,733

(22) PCT Filed: Apr. 28, 2010
(86) PCT No.: PCT/AU2010/000485

§ 371 Date: Jan. 25, 2012

(30) Foreign Application Priority Data
Apr. 28, 2009 (AU) 2009901840

(51) Int. Cl. B32B 5/02; B23P 11/00; B05D 1/02; D04H 5/02; B05D 7/00; B05D 3/00

(52) U.S. Cl. 442/86; 427/372.2; 28/103; 29/428

(57) ABSTRACT

The invention relates to a membrane comprising a geotextile and a water impermeable cured cementitious composition which is disposed on at least one side of the geotextile. The cured cementitious composition comprises a binder polymer, cement and at least two different fillers.

### TECHNICAL FIELD

The present invention relates to a membrane for use as a liner in water channels and water storages.

### BACKGROUND OF THE INVENTION

Traditional polymeric liners and geomembranes used to lined irrigation channels and waterways, such as high-density polyethylene (HDPE), suffer from a number of limitations such as low puncture resistance on angular rocky subgrades, low puncture resistance toward animal damage (e.g. kangaroo claws, cow hoofs), susceptibility to installation damage, relatively low tear strength, very slippery surfaces, susceptibility to fire damage, and difficulty to weld and repair after many years of exposure.

There is therefore a need for a new liner material which overcomes at least some of the above limitations of the commonly used HDPE liners.

### OBJECT OF THE INVENTION

It is the object of the present invention to at least partially satisfy the above need.

### SUMMARY OF THE INVENTION

In a first aspect of the invention there is provided a membrane. The membrane may be suitable for use as a liner in water channels and/or for use as a liner in water storages. The water channels and/or water storages may be for potable water. They may be for waste water. They may be for some other type of water. The membrane comprises a geotextile and a water impermeable cured cementitious composition disposed on at least one side of the geotextile. The cured cementitious composition may be suitable to withstand mechanical, human and/or animal traffic. The cured cementitious composition comprises:

a binder polymer;

cement;

a first filler; and

a second filler which is different to the first filler.

The following options may be used in conjunction with the first aspect, either individually or in any suitable combination.

The binder polymer may be an ethylene-vinyl acetate copolymer. The ethylene-vinyl acetate copolymer may comprise about 80 to about 90% by weight of vinyl acetate derived monomer units. The binder polymer may be present at about 10 to about 80% by weight of the cured cementitious composition, or about 20 to about 60%, e.g. about 42%.

The cement may be present at about 5 to about 50% by weight of the cured cementitious composition, or about 10 to about 30%, e.g. about 20%.

The first filler may be a non-reinforcing filler. It may comprise, or may consist essentially of, sand. The sand may have a mean particle size of about 0.06 to about 0.3 mm. The first filler may be present at about 5 to about 50% by weight of the cured cement composition, or about 10 to about 30%, e.g. about 23%.

The second filler may be a reinforcing filler. It may comprise, or may consist essentially of, calcium carbonate. The calcium carbonate may have a mean particle size of about 0.5 to about 5 microns. The second filler may be present at about 2 to about 50% by weight of the cured cementitious composition, or about 5 to about 20%, e.g. about 10%.

The cured cementitious composition may additionally comprise a third filler. The third filler may comprise, or consist essentially of, sand, clay or a mixture of these. It may be present at about 1 to about 10% by weight of the cured cementitious composition, or about 2 to about 5%.

The cured cementitious composition may additionally comprise a pigment. It may additionally comprise a UV absorber. The combined amount of the pigment and the UV absorber (if present) may be less than about 2% by weight of the cured cementitious composition.

The organic polymer may comprise a plasticiser.

The geotextile may comprise, or may consist essentially of, a geofabric, a geogrids or some other structurally engineered composite.

The cured cementitious composition may be present as a layer on and/or in the geotextile. The layer may be at least about 2 mm thick, or may be about 2 to about 5 mm thick.

The geotextile may be a composite geotextile comprising a woven/knitted geotextile attached to a non-woven geotextile. The cured cementitious composition may be disposed on the woven/knitted geotextile, such that the non-woven geotextile is disposed on one side of the woven/knitted geotextile and the cementitious composition is disposed on another side of the woven/knitted geotextile. At least some of the fibres of the non-woven geotextile may penetrate through the woven/knitted geotextile. They may penetrate into the cementitious composition.

In an embodiment there is provided a membrane for use as a liner in water channels, comprising a geotextile and a water impermeable cured cementitious composition disposed on at least one side of the geotextile, said cured cementitious composition comprising:

EVA copolymer (about 80 to about 90 wt % VA-derived monomer units) about 20-60 wt %;

Portland cement about 10-30 wt %;

sand about 10-30 wt %;

calcium carbonate about 5-20 wt %;

clay and/or sand about 1-10 wt %; and

pigment and UV absorber under about 2 wt %.

In another embodiment there is provided a membrane for use as a liner in water channels, comprising:

a composite geotextile comprising a woven/knitted geotextile attached to a non-woven geotextile, and

a water impermeable cured cementitious composition disposed on the woven/knitted geotextile, such that the non-woven geotextile is disposed on one side of the woven/knitted geotextile and the cementitious composition is disposed on another side of the woven/knitted geotextile, wherein at least some of the fibres of the non-woven geotextile penetrate through the woven/knitted geotextile and into the cementitious composition,

said cured cementitious composition comprising:

EVA copolymer (about 80 to about 90 wt % VA-derived monomer units) about 20-60 wt %;

Portland cement about 10-30 wt %;

sand about 10-30 wt %;

calcium carbonate about 5-20 wt %;

clay and/or sand about 1-10 wt %; and

pigment and UV absorber under about 2 wt %.

In a second aspect of the invention there is provided a process for making a membrane. The membrane may be suitable for use as a liner in water channels and/or for use as a liner in water storages. The process comprises:
(i) applying an aqueous coating mixture onto a geotextile; and
(ii) allowing the coating mixture to set so as to form a cured cementitious composition in and/or on the geotextile.
   The aqueous coating mixture comprises a water dispersible polymer, cement, a first filler, a second filler which is different to the first filler, and water.

The following options may be used in conjunction with the second aspect, either individually or in any suitable combination.

The applying may comprise spraying. It may comprise some other convenient method of applying, e.g. wiping, painting, rolling, pouring or a combination of such suitable methods.

The aqueous coating mixture may have a solids content of about 60 to about 80% by weight.

The water dispersible polymer may form the binder polymer as the coating mixture sets to form the cured cementitious composition. The water dispersible polymer may be present at about 10 to about 80% by weight of the solids of the aqueous coating mixture. The cement may be present at about 5 to about 50% by weight of the solids of the aqueous coating mixture. The first filler may be present at about 5 to about 50% by weight of the solids of the aqueous coating mixture. The second filler may be present at about 2 to about 50% by weight of the solids of the aqueous coating mixture.

The aqueous coating mixture may additionally comprise a third filler. The third filler may be present at about 1 to about 10% by weight of the solids of the aqueous coating mixture.

The aqueous coating mixture may additionally comprise one or more of a pigment, a UV absorber and a setting accelerator. The total weight of the pigment, UV absorber and setting accelerator may be less than about 2% of the solids of the aqueous coating mixture.

Step (i) of the process may deposit a layer of the coating mixture on the geotextile. The layer may be at least about 2 mm thick, or may be about 2 to about 5 mm thick.

The geotextile and the aqueous coating mixture may be such that the mixture at least partially penetrates the geotextile.

The process may comprise the step of combining a water dispersible polymer, cement, a first filler, a second filler which is different to the first filler, and water and optionally one or more of a third filler, a pigment, a UV absorber and a setting accelerator, so as to form the aqueous coating mixture.

The geotextile may be a composite geotextile comprising a woven/knitted geotextile attached to a non-woven geotextile. Thus the composite geotextile may have a woven/knitted face and a non-woven face. The process may comprise the step of attaching the woven/knitted geotextile to the non-woven geotextile. The step of attaching may comprise needle punching. The needle punching may be from the non-woven geotextile into the woven/knitted geotextile. Step (i) of the process may comprise applying the aqueous coating mixture onto the woven/knitted face of the composite geotextile. The process may comprise locating the geotextile in place before step (i).

The aqueous coating mixture may be such that it cures to form a waterproof cementitious composition in and/or on the geotextile, i.e. that the cured cementitious composition formed in step (ii) is waterproof. The aqueous coating mixture may be applied to the geotextile in sufficient thickness to form a waterproof membrane.

In an embodiment there is provided a process for making a membrane for use as a liner in water channels, said process comprising:
(i) spraying an aqueous coating mixture onto a geotextile; and
(ii) allowing the coating mixture to set so as to form a cured cementitious composition in and/or on the geotextile,
   wherein the aqueous coating mixture comprises:

EVA polymer (about 80 to about 90 wt % VA-derived monomer units) about 20-60 wt % of the solids of the mixture;

Portland cement about 10-30 wt % of the solids of the mixture;

sand about 10-30 wt % of the solids of the mixture;

calcium carbonate about 5-20 wt % of the solids of the mixture;

clay and/or sand about 1-10 wt % of the solids of the mixture;

pigment and UV absorber under about 2 wt % of the solids of the mixture; and

water about 35% of the above solids.

In another embodiment there is provided a process for making a membrane for use as a liner in water channels, said process comprising:
(i) attaching a woven/knitted geotextile to a non-woven geotextile by needle punching from the non-woven geotextile into the woven/knitted geotextile so as to form a composite geotextile;
(ii) spraying an aqueous coating mixture onto the composite geotextile; and
(iii) allowing the coating mixture to set so as to form a cured cementitious composition in and/or on the geotextile,
   wherein the aqueous coating mixture comprises:

EVA polymer (about 80 to about 90 wt % VA-derived monomer units) about 20-60 wt % of the solids of the mixture;

Portland cement about 10-30 wt % of the solids of the mixture;

sand about 10-30 wt % of the solids of the mixture;

calcium carbonate about 5-20 wt % of the solids of the mixture;

clay and/or sand about 1-10 wt % of the solids of the mixture;

pigment and UV absorber under about 2 wt % of the solids of the mixture; and

water about 35% of the above solids.

In another embodiment there is provided a process for making a membrane for use as a liner in water channels, said process comprising:
(i) attaching a woven/knitted geotextile to a non-woven geotextile by needle punching from the non-woven geotextile into the woven/knitted geotextile so as to form a composite geotextile having a woven/knitted face and a non-woven face;
(ii) locating the composite geotextile on a surface, e.g. of a water channel, such that the non-woven face is adjacent the surface;
(iii) spraying an aqueous coating mixture onto the woven/knitted face of the composite geotextile; and
(iv) allowing the coating mixture to set so as to form a cured cementitious composition in and/or on the geotextile,
   wherein the aqueous coating mixture comprises:

EVA polymer (about 80 to about 90 wt % VA-derived monomer units) about 20-60 wt % of the solids of the mixture;

Portland cement about 10-30 wt % of the solids of the mixture;

sand about 10-30 wt % of the solids of the mixture;

calcium carbonate about 5-20 wt % of the solids of the mixture;

clay and/or sand about 1-10 wt % of the solids of the mixture;

pigment and UV absorber under about 2 wt % of the solids of the mixture; and

water about 35% of the above solids.

In a third aspect of the invention there is provided the use of a membrane according to the first aspect for waterproofing a surface. The surface may be the surface of a water channel or the inner surface of a water storage vessel or some other suitable surface requiring waterproofing.

In a fourth aspect of the invention there is provided a method for waterproofing a surface, said method comprising securing a membrane according to any the first aspect to said surface. The surface may be the surface of a water channel or the inner surface of a water storage vessel or some other suitable surface requiring waterproofing. The method may additionally comprise sealing any holes in the membrane. It may also comprise sealing between sheets of the membrane so as to prevent water passing between said sheets.

In a fifth aspect of the invention there is provided the use of a geotextile and an aqueous coating mixture for making a membrane. The coating mixture comprises a water dispersible polymer, cement, a first filler, a second filler which is different to the first filler, and water, and optionally one or more of a third filler, a pigment, a UV absorber and a setting accelerator.

### DETAILED DESCRIPTION OF THE PREFERRED EMBODIMENTS

The present invention provides a settable, polymer-modified cementitious composition or aqueous coating mixture which can be applied by spraying or painting to form a water impervious coating on geotextile materials. Suitable geotextile materials include geofabrics (woven and non-woven, as well as composite geofabrics having both woven and non-woven components), geogrids and other structurally engineered textile composites. The composite liner may have application as a structural water barrier for irrigation channels, canals, water storages etc. The aqueous coating mixture is one that may be used in other applications, for example as a tile adhesive. However the present inventors have found that when applied to a geotextile substrate, a membrane may be formed that has excellent waterproofing properties for use as a waterproofing liner in applications such as water channels and water storage vessels, and in suitable embodiments is capable of withstanding many of the physical and radiation stresses to which it may be exposed in such applications. The membrane may also have a degree of flexibility, which enhances its ability to withstand physical stresses for example impacts. Thus the membrane (liner) comprises a cementitious compound (flexible concrete) which is applied to a range of geocomposites/geotextiles to provide a durable, robust yet flexible impermeable liner system. The niche position the membrane occupies is its ability to be an engineered solution as an alternative to thick inflexible concrete structures at one end of the spectrum, to polyolefins, such as HDPE at the other. It is a fit for service liner system as opposed to a “make do” amalgamation of existing, yet in most cases, inappropriate materials. The cured cementitious composition of the membrane may be resilient. It may be at least partially flexible. It may have sufficient resilience and/or flexibility and/or strength that the membrane is capable of withstanding traffic (e.g. human and/or animal and/or vehicular traffic) in the selected application. For example when the membrane is used for lining a water channel, the composition may have sufficient resilience and/or flexibility and/or strength that the membrane is capable of withstanding traffic of human and cattle traversing the membrane, since in this application it is not uncommon for animals (e.g. cattle) and/or humans to cross the water channel. In other applications, for example when used as a lining on a roadway, the composition may have sufficient resilience and/or flexibility and/or strength that the membrane is capable of withstanding vehicular traffic. In both of these examples of applications, the resilience and/or flexibility and/or strength of the composition may be such that it retains its waterproof property while being subjected to the traffic.

In a preferred embodiment the coating (i.e. cured cementitious composition) is based on an elastomeric latex emulsion, cement, sand, mineral fillers such as calcium carbonate, a defoamer, and heat and UV stabilizers. The spray applied geomembrane liner fully seals the geotextile support to provide a seamless liquid barrier and provide an economical containment system. The spray applied membrane liner has the added advantage of ease of use when complex detail work is required. Furthermore, unlike sheet geomembranes presently in use, the spray applied liner can be formulated and modified for customised properties such as chemical resistance, hardness, flexibility, or texture if required. One or more fillers may be such that the membrane has a textured surface, or a non-slip surface. This may be for example achieved by using coarse sand particles or other relatively large particle sized filler to provide enhanced surface friction. This may enable humans and/or animal to walk on the membrane, e.g. walk into channels and ponds with steep slopes and being lined by the membrane, without slipping or sliding. A textured or non-slip surface may also be advantageous when the membrane is used for lining a surface for vehicular traffic such as a roadway. In this event it may prevent skidding of vehicles travelling on the surface lined with the membrane when the membrane is wet, as well as preventing pedestrians and/or animals from slipping on the wet surface.

The cured cementitious coating may coat the geotextile in part or in full. It may coat the geotextile sufficiently to render the resulting membrane waterproof or water resistant over at least a part, optionally over all, of its area. Thus in preparing the membrane the aqueous coating mixture may be applied to at least a portion of one side, optionally an entire side, of the geotextile. It may be applied in sufficient quantity to provide a waterproof or water resistant coating.

Since the spray-on liner is water-borne, the spray may be applied over wet or damp geotextile, making installation possible during adverse weather conditions such as drizzle, fog, high humidity, condensation or precipitation. In contrast, thermoplastic geomembranes such as HDPE cannot be welded if there is any surface moisture present as this leads to porosity in the weld zones which jeopardises waterproofing properties. It should be recognised that, whereas spraying is a convenient method for applying the coating to the geotextile or other substrate, other methods may also be used, such as rolling, pouring, spreading, etc. as well as combinations of such methods.

The aqueous coating mixture used in the present invention may have low or no volatile organic compounds (VOCs). This provides a safety and environmental benefit to its use, particularly where large areas of membrane are made and used. The mixture may have no organic solvents. It may have a VOC content of less than about 2%, or less than about 1, 0.5, 0.2 or 0.1%. It may have a 0% VOC content. It may comprise no intentionally added VOCs. In order to achieve or improve stability of the aqueous coating mixture, a surfactant may be present in the mixture. It may be present in sufficient quantity that the solids of the mixture are water compatible (i.e. water soluble, or water dispersible, or water suspendable). The surfactant may be a cationic surfactant, or it may be an anionic surfactant, or it may be a non-ionic surfactant, or it may be a zwitterionic surfactant. Non-ionic surfactants may be used so as to avoid problems with the ionic content of the aqueous coating mixture. Suitable non-ionic surfactants include alkylphenylethoxylate surfactants, ethylene oxide-propylene oxide copolymer surfactants and other similar materials. Mixtures of surfactants (or of a surfactant and a cosurfactant) may also be used. The surfactant(s) may be present in about 1 to about 5% by weight of the solids of the aqueous mixture, and may also carry through to the cured cementitious composition. They may be present in about 1 to 3, 3 to 5 or 2 to 4%, e.g. about 1, 2, 3, 4 or 5%. In some cases they may be present in greater or lesser quantity than this.

The present invention seeks to combine the economics of sheet liner materials with the detailed encapsulation capabilities of a spray applied material so as to provide an effective containment system for a wide range of applications. Whereas spray-on liners) based on polyurethane and polyurea are known, these contain solvents or volatile precursors such as isocyanates, leading to undesirably high volatile organic content (VOC)levels. Unlike these spray-on liners, the present invention has the advantage of being water borne, and hence represents a non-VOC, or very low VOC, coating system.

The proportions of the solid components of the aqueous coating mixture may be such that on addition of about 30% (by weight of the solid components) of water they are capable of forming an aqueous dispersion of appropriate rheology to allow spraying or painting. It is thought that, during setting of the aqueous coating mixture, a chemical interaction occurs between cementitious and polymeric materials in the mixture, whereby acetate groups of EVA copolymer undergo alkaline hydrolysis and interact with calcium ions of the cementitious materials to form an organic salt (e.g. calcium acetate). The coatings may develop their full strength within about 28 days.

Geocomposites are generally made by laminating various layers of geotextiles, geomembranes and geogrids. One of the principle disadvantages of these system is that they suffer from poor ply adhesion. For instance, reinforced geomembranes may be made by laminating together two geomembrane plys with a fabric reinforcing scrim between them. The geomembrane's performance depends on its ability to function as a single unit. If the layers are not adequately adhered together, the performance of the reinforced geomembrane may be adversely affected. Delamination damage occurs when various layers separate and the geocomposites no longer performs as a single unit.

Woven/knitted geotextiles may be mechanical bonded to non-woven geotextiles by needle punching the non-woven geotextile face such that fibres from the non-woven geotextile are pushed through the woven/knitted geotextile to create mechanical anchoring points. The needlepunching process gives rise to a large number of fibres penetrating the woven material.

The woven/knitted geotextiles commonly consist of polymer yarns in an open woven/knitted pattern sufficient to achieve interpenetration of the needle-punched non-woven geofabrics fibres.

Whilst mechanically bonding the woven/knitted geotextile/fabric to the non-woven geotextile by needlepunching serves to bond the two layers sufficiently for handling and field deployment, the ply adhesion values are nevertheless rather low (<20 N).

It has been advantageously found that the application of flexible geocoating such as a cementitous coating (as for example described elsewhere herein) to the woven/knitted geotextile/fabric side of the assembly locks the protruding fibres of the needle-punched non-woven geofabrics in place, effectively preventing fibre pullout. The ‘locking in’ of these protruding needle-punched fibres leads to a large increase (some 10 fold) in ply adhesion of the bonded assembly. The coating adhesion combined with the encapsulation of the exposed non-woven geotextile fibres prevents the fibres being pulled back through the woven/knitted geotextile/fabric reinforcement on the application of peel, shear or tensile stresses.

This development leads to the manufacture of geocomposites that act monolithically and advantageously resist shear, peel and tensile delamination.

Thus in an embodiment of the invention there is provided a membrane comprising a woven/knitted geotextile, a non-woven geotextile and a water impermeable cured cementitious composition. The non-woven geotextile may be disposed on one side of the woven/knitted geotextile and the cementitious composition may be disposed on another side of the woven/knitted geotextile. The cured cementitious composition may comprise a binder polymer, cement, a first filler and a second filler which is different to the first filler. Details of these components and of other optional components of the cementitious composition are described elsewhere herein.

In this embodiment, some of the fibres of the non-woven geotextile may penetrate through the woven/knitted geotextile and into the cured cementitious composition. This may be readily achieved if the non-woven geotextile is attached to the woven/knitted geotextile by needle punching.

In a related embodiment there is provided a process for making a membrane, or for forming a membrane on a surface. The membrane may be suitable for use as a liner in water channels and/or for use as a liner in water storages (i.e. on the surface thereof). The process comprises applying, e.g. spraying, an aqueous coating mixture onto one side of a woven/knitted geotextile, said woven/knitted geotextile having a non-woven geotextile attached to another side thereof, and allowing the coating mixture to set so as to form a cured cementitious composition in and/or on the woven/knitted geotextile. The process may comprise attaching the woven/knitted geotextile to the non-woven geotextile. The attaching may comprise needle punching. The needle punching may be from the non-woven geotextile through the woven/knitted geotextile. The attaching may be conducted prior to allowing the coating mixture to set, and may be conducted prior to applying the aqueous coating mixture to the side of the woven/knitted geotextile.

Commonly the aqueous coating mixture is quite heavy, and the final membrane is therefore also quite heavy. Whereas the membrane is flexible, it is not as flexible as the two ply geotextile consisting of the woven/knitted geotextile attached to the non-woven geotextile. It is therefore convenient to attach the woven/knitted geotextile to the non-woven geotextile (e.g. by needle punching) to form a composite geotextile having a woven/knitted face and a non-woven face. This may be located in place, optionally on a surface, where the membrane is required (e.g. in an irrigation channel) with the unwoven face adjoining a solid surface (e.g. the surface of the irrigation channel), and the aqueous coating mixture may then be applied to the woven/knitted face of the composite geotextile and allowed to set therein and/or thereon so as to form the membrane in situ.

The aqueous coating mixture which may be used in this embodiment has been described elsewhere herein.

A benefit of using a composite geotextile as described above is that the woven/knitted geotextile provides tear strength to the composite geotextile whereas the non-woven geotextile provides puncture resistance. Additionally, use of a non-woven geotextile reduces the required thickness of woven/knitted geotextile. Since the non-woven geotextile is commonly lighter in weight than the woven/knitted geotextile, this reduces the weight of the composite geotextile.

The invention also provides a membrane for use as a liner in water channels, comprising a geotextile and a cured cementitious composition. A preferred coating is a latex modified Portland cement mortar (polymer modified mortar: PMM) based on poly(ethylene-co-vinyl acetate) (EVA) and formulated to produce a sprayable coating for geotextile substrates. The cured cementitions composition (i.e. the various components thereof) may be such that the membrane retains appropriate physical properties (strength, flexibility, resilience, tack free surface etc.) for the application in which it is used for the lifetime of the membrane under the conditions to which it exposed in use. The cured cementitious composition (and the aqueous mixture from which it is made) comprises the following components:
polymer: The polymer of the aqueous coating mixture should be water dispersible, so as to allow it to be dispersed in water in order to form the aqueous mixture. Once the aqueous mixture is cured to form the cured cementitious coating, the polymer, although the same chemical material, may be non-dispersible in water. A modified redispersible EVA (ethylene-vinyl acetate copolymer) is preferred as the binder (i.e. the water dispersible polymer). The proportion of vinyl acetate derived monomer units in the copolymer may be about 50 to about 95% on a weight or molar basis, or about 50 to 90, 50 to 80, 50 to 70, 60 to 95, 70 to 95, 80 to 95, 60 to 90, 60 to 80, 70 to 90, 70 to 80 or 80 to 90%, e.g. about 50, 55, 60, 65, 70, 75, 80, 85, 90 or 95% by weight or by moles. Other water dispersible organic polymers which may be used include a wide range of homopolymers or copolymers of ethylenically unsaturated monomers or naturally occurring polymers. The EVA or EVA copolymer may be partially hydrolysed so that it has alcohol groups. It may be for example about 1 to about 20% hydrolysed, or about 1 to 10, 1 to 5, 10 to 20 or 5 to 10%, e.g. about 1, 2, 3, 4, 5, 6, 7, 8, 9, 10, 15, 20%. Suitable organic polymers may comprise polar groups, preferably chemical groups which are hydrolysable by base, in particular by the basic materials (e.g. cement) present in the mixture. They may for example comprise ester groups (e.g. acetates) or alcohol groups. They may be hydrolysable to form acid salts with the basic materials, in particular to form carboxylate salts, e.g. calcium acetate. These may serve to bind the resulting cured composition. Another suitable polymer is VA-VE-E (vinyl acetate/vinyl ester/ethylene) terpolymer, for example as sold under the name Vinnapas™ 7055N. Examples of suitable polymers include styrene containing copolymers, styrene/butadiene copolymers, divinylstyrene containining polymers or copolymers with styrene, alkyl (e.g. methyl or ethyl) acrylate or methacrylate polymers or copolymers, copolymers of styrene with an alkyl (e.g. methyl) methacrylate or maleic anhydride, acrylic and acrylic ester resins, vinyl acetate polymers and copolymers of vinyl acetate with ethylene or other olefins (e.g. ethylene-vinyl acetate copolymers), plasticised vinyl chloride-vinyl acetate copolymers etc. The water dispersible polymer may be in the form of a latex. It may be redispersible. In some embodiments the polymer is provided as a dispersion, e.g. an emulsion, in water. The dispersion may comprise a surfactant for stabilising the dispersion. It may be an ionic (cationic or anionic) surfactant, or may be a non-ionic or zwitterionic surfactant. In some cases the polymer may be made in the dispersion, i.e. it may be an emulsion polymer or a suspension polymer. Plasticisers, such as Cereclor (a chlorinated paraffin), phthalate esters (e.g. dioctyl phthalate, benzyl phthalate, butyl benzyl phthalate—Santiciser® 160) etc., may be used in order to improve flexibility to the resulting membrane. Other plasticisers may be used depending on the nature of the polymer. The proportion of the water dispersible polymer in the cured cementitious coating, or in the solids of the aqueous coating mixture, may be about 10 to about 80% by weight, or about 20 to 60, 10 to 60, 10 to 40, 20 to 80, 50 to 80, 20 to 40, 40 to 60 or 40 to 50%, e.g. about 10, 15, 20, 25, 30, 35, 40, 41, 42, 43, 44, 45, 50, 55, 60, 65, 70, 75 or 80% by weight. A preferred redispersable EVA binder for the present invention has the following characteristics:

| | |
|---|---|
| Glass transition temperature - Tg (° C.) | −7 |
| % Mass of Acetate | 87% |
| % Mass of Ethylene | 13% |

A suitable redispersable EVA powdered polymer is sold by Wacker under the tradename Vinnapas™ RE 547Z, having a glass transition temperature of −7° C. This powder is manufactured by spray drying an aqueous emulsion of modified EVA. The aqueous coating mixture is preferably based on EVA emulsions which are polyvinyl acetate (PVAc) copolymers based on vinyl acetate (VA) internally plastized with vinyl acetate ethylene (VAE). Poly(vinyl acetate) and vinyl acetate-ethylene (VAE) copolymers are the preferred binder polymer for the mixture, however polymer blends involving poly(vinyl acetate) and VAE with styrene-acrylic acid and acrylate-acrylic acid copolymers may also be used. Vinyl acetate-ethylene (VAE) Copolymer Emulsions resins sold under such trade names as: Airflex (Air Products and Chemicals, Inc), Elvace (DuPont), Vinnapas (Wacker), Mowilith (Hoechst), Sumikaflex (Sumitomo), AmscoRes (Union Oil Corporation), and Vinivil (Montecatini Edison). These products, with 5-40 wt % ethylene in the copolymer are generally supplied commercially as emulsions or dispersions in water. They may be viewed as modifications of polyvinyl acetate with ethylene.
cement: a suitable cement is Portland cement. In order to increase the setting (drying) speed of the coating, a high alumina cement may be used. High alumina cement, according to British Standard 915 Part 2, is a cement which contains not less than 32% by weight of alumina and has an alumina to calcium oxide ratio of between 0.85 and 1.3:1. The alumina content may be at least about 32, 35, 40, 45 or 50%, e.g. about 32 to 50, 40 to 50, 35 to 45 or 35 to 40%, e.g. about 32, 35, 40, 45 or 50%. It may have an alumina to calcium oxide ratio of between about 0.85:1 and 1.2:1, 0.85:1 and 1:1, 0.9:1 and 1.3:1, 1:1 and 1.3:1, 1.1:1 and 1.3:1, 0.9:1 and 1.1:1, 0.9:1 and 1:1 or 1:1 and 1.1:1, e.g. about 0.85, 0.9, 0.95, 1, 1.05, 1.1, 1.15, 1.2, 1.25 or 1.3:1. The proportion of the cement in the cured cementitious coating, or in the solids of the aqueous coating mixture, may be about 5 to about 50% by weight, or about 5 to 40, 5 to 30, 5 to 20, 10 to 50, 20 to 50, 30 to 50, 10 to 40, 10 to 30, 20 to 30 or 30 to 40%, e.g. about 5, 10, 15, 20, 25, 30, 35, 40, 45 or 50%. The cement may be a Portland cement blend (e.g. Portland blast furnace cement, Portland flyash cement, Portland pozzolan cement, Portland silica fume cement, masonry cement, expansive cement). It may be a white blended cement, a colored cement, a very finely ground cement, a Pozzolan-lime cement, a slag-lime cement, a supersulfated cement, a caclium aluminate cement, a calcium sulfoaluminate cement, a “natural” cement, a geopolymer cement. It may be a mixture or blend of any two or more of these types of cement.
a first filler: the first filler may be a non-reinforcing filler. It may comprise a particulate material. It may comprise a siliceous material. It may comprise for example sand, ground glass, crushed rock etc. It may comprise a mixture of any two or more of these. If ground glass is used, this may serve as a suitable reuse for waste glass. The particle size may be about 0.05 to about 0.3 mm. This may be a mean particle diameter or it may be a maximum particle diameter. The particle size may be about 0.05 to 0.2, 0.05 to 0.1, 0.1 to 0.3, 0.2 to 0.3, 0.06 to 0.3, 0.1 to 0.2 or 0.06 to 0.1 mm, e.g. about 0.05, 0.06, 0.07, 0.08, 0.09, 0.1, 0.15, 0.2, 0.25 or 0.3 mm. The proportion of the first filler in the cured cementitious coating, or in the solids of the aqueous coating mixture, may be about 5 to about 50% by weight, or about 5 to 40, 5 to 30, 5 to 20, 10 to 50, 20 to 50, 30 to 50, 10 to 40, 10 to 30, 20 to 30 or 30 to 40%, e.g. about 5, 10, 15, 20, 21, 22, 23, 24, 25, 30, 35, 40, 45 or 50%. A suitable first filler is sand. It mayu be graded sand. It may be for example 30% graded sand. It may be a mixture of coarse sand and find sand. The coarse sand may be about 18 to about 40 mesh. The fine sand may be about 600 mesh. Suitable sands for use in the invention are available from Rocla Quarry Products Pty Ltd as 18-40 Silica Sand, 200-600 Silica Sand and 16-30 Silica Sand. Blends of any two or more of these may also be used.
second filler: the second filler is different to the first filler. It may be a reinforcing filler, i.e. it may improve the physical properties (e.g. strength, toughness, tear resistance) of the cured cementitious coating. A suitable reinforcing filler is calcium carbonate. Commonly the calcium carbonate will not be surface treated, although in some cases it may be surface treated, for example so as to improve its compatibility with the polymer. The second filler may have a particle size of about 0.5 to about 5 microns, or about 1 to 5, 2 to 5, 0.5 to 2, 0.5 to 1 or 1 to 3 microns, e.g. about 0.5, 1, 1.5, 2, 2.5, 3, 3.5, 4, 4.5 or 5. The particle size may be a mean particle size or may be a maximum particle size. The proportion of the second filler in the cured cementitious coating, or in the solids of the aqueous coating mixture, may be about 2 to about 50% by weight, or about 2 to 20, 2 to 10, 5 to 50, 5 to 20, 5 to 10, 10 to 50, 20 to 50, 5 to 15, 5 to 10 or 10 to 20%, e.g. about 5, 10, 11, 12, 13, 14, 15, 20, 25, 30, 35, 40, 45 or 50%. A suitable calcium carbonate for use in the invention is Omyacarb® 20BG. Other suitable reinforcing fillers that may be used as the second filler include wollastonite, in particular highly acicular wollastonite, and a water swellable cellulosic fibre (e.g. Methocell® or RT fibres from Interfiber Ltd.) which are capable of providing a reinforced and resilient coating. In some cases the second filler is a mixed filler, e.g. a mixture of any two or more of the suitable second fillers mentioned above.

Any one or more of the following optional components may be present:
third filler: suitable materials which may be used as the third filler include sand, clay or a mixture of these. Other suitable materials include inorganic fillers from recycled sources such as recycled crushed glass or aluminium silicates. Elastomeric fillers such as ground tyre crumb may be added to impart additional flexibility and resilience. Mixtures of any two or more of the above materials may be used. The proportion of the third filler in the cured cementitious coating, or in the solids of the aqueous coating mixture, may be about 1 to about 10% by weight, or about 1 to 5, 1 to 2, 2 to 10, 5 to 10 or 2 to 5%, e.g. about 1, 2, 3, 4, 5, 6, 7, 8, 9 or 10% by weight.

The composition may also contain fly ash, such as is produced in pulverized-coal-fired boilers at power stations and which mainly consists of aluminosilicate glass microsphere. It may also comprise synthetic hollow microspheres e.g. hollow glass microspheres. Other inorganic fillers which may be used include: aluminate, pozzolanic, slag, magnesia, phosphate cements and gypsum.
pigment: the pigment may be an organic pigment or it may be an inorganic pigment. It may be a water soluble pigment. It may be a particulate pigment. It may be a hydrophilic pigment. It may for example comprise carbon black in order to produce a black membrane. This may also function as a UV absorber or UV protectant (see below). The proportion of the pigment (if present) may depend on the nature of the pigment. It may for example be less than about 2% by weight, or less than about 1.5 or 1%, or about 0.5 to 2, 0.5 to 1, 1 to 2 or 0.5 to 1.5%, e.g. about 0.5, 1, 1.5 or 2%. In some cases a mixture of two or more pigments may be used.
UV absorber/UV protectant: these are provided to reduce or prevent UV damage to the membrane when used in outdoor applications. A common use for the membrane is as a channel liner for irrigation channels. In such applications it is useful to provide a UV protectant so as to reduce the impact of sunlight on the polymer and hence on the membrane. The UV absorber may be an organic UV absorber. It may be a water soluble UV absorber. It may be a hydrophilic UV absorber. It may be a water dispersible UV absorber. The proportion of the UV absorber (if present) may depend on the nature thereof, in particular on its UV extinction coefficient, more particularly the UV extinction coefficient at the wavelength or wavelengths which are capable of damaging or degrading the membrane (in particular the binder polymer). The composition may comprise a UV stabliser, e.g. a hindered amine light stabiliser. It may comprise a light stabiliser with or without a UV absorber, to provide a UV protection system. In the present specification, unless the context indicates the contrary, whereever reference is made to a UV absorber, this may be replaced or supplemented with a UV stabiliser (which may or may not be a UV absorber) in order to provide a UV protection system affording the membrane the desired level of UV resistance/stabilisation. It may be present in sufficient concentration to provide the desired level of UV protection, or the desired length of outside exposure lifetime. In some cases a mixture of two or more UV absorbers, or a UV absorber together with a light stabiliser (e.g. a hindered amine light stabiliser or HALS) may be used. Thus the composition may comprise an effective amount, commonly from about 0 to about 0.1% (or about 0.01 to 0.1, 0.05 to 0.1, 0.01 to 0.05 or 0.02 to 0.06%, e.g. about 0.01, 0.02, 0.03, 0.04, 0.05, 0.06, 0.07, 0.08, 0.09 or 0.1%) by weight, of a UV light stabilizer such as Tinuvin® 292 UV light stabilizer from Ciba-Geigy. It may also comprise an effective amount, commonly from about 0 to 0.2% (or about 0.01 to 0.2, 0.02 to 0.2, 0.02 to 0.2, 0.1 to 0.2, 0.01 to 0.1, 0.01 to 0.05 or 0.02 to 0.1%, e.g. about 0.01, 0.02, 0.03, 0.04, 0.05, 0.06, 0.07, 0.08, 0.09, 0.1, 0.15 or 0.2%) by weight of a UV light absorber such as Tinuvin® 1130 UV light absorber from Ciba-Geigy. UV protection may be particularly important in cases where the geotextile or the cured composition are UV sensitive, as this may otherwise cause UV degradation when the membrane is used in outdoor applications. Polyolefins such as polypropylene are known to be UV sensitive, and in cases where the geotextile comprises polypropylene, it is preferred that a suitable UV protection system such as described herein be used if outdoor applications are envisaged.
others: The coating composition, or the solids of the aqueous mixture, may further comprises an effective amount, commonly about 0 to about 1% by weight (or about 0.1 to 1, 0.5 to 1, 0.1 to 0.5, 0.1 to 0.3, 0.3 to 0.7, e.g. about 0.1, 0.2, 0.3, 0.4, 0.5, 0.6, 0.7, 0.8, 0.9 or 1%) of a defoaming agent. The defoaming agent may be a silicone defoamer. It may be for example Colloid 643® defoamer from Rhone-Poulenc. It may also comprise an effective amount, commonly from about 0 to about 1% by weight (or about 0.05 to 1, 0.1 to 1, 0.2 to 1, 0.5 to 1, 0.05 to 0.5, 0.05 to 0.2 or 0.1 to 0.3%, e.g. about 0.05, 0.1, 0.15, 0.2, 0.25, 0.3, 0.35, 0.4, 0.45, 0.5, 0.6, 0.7, 0.8, 0.9 or 1 wt. %) of an antioxidant (for example Irganox® 1010 antioxidant from Ciba-Geigy). It may also comprise carbon black, e.g. having a particle size of about 20 nm. A suitable carbon black is Printex Alpha® from Degussa. The carbon black may be present at up to about 2% by weight, or up to about 1.5, 1 or 0.5%, or about 0.1 to about 2%, or about 0.2 to 2, 0.5 to 2, 1 to 2, 0.1 to 1, 0.1 to 0.5 or 0.5 to 1%, e.g. 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9 or 2%, or even higher, e.g. 2.5 or 3% by weight. It may also comprise up to about 1% titanium dioxide (e.g. from Tioxide), or up to about 0.5 or about 0.2% or about 0.1 to about 1%, or about 0.5 to 1, 0.1 to 0.5 or 0.3 to 0.7% by weight, e.g. about 0.1, 0.2, 0.3, 0.4, 0.5, 0.6, 0.7, 0.8, 0.9 or 1% by weight. The carbon black and the titanium dioxide may function as UV protectants, e.g. UV blockers or absorbers. They may serve as pigments. They may serve both functions. They may serve as opacifiers, particularly opacifiers in the UV range, more particularly opacifiers at the wavelength or wavelengths which are capable of damaging or degrading the membrane (in particular the binder polymer). The aqueous mixture may additionally comprise a retarder, e.g. calcium carbonate, to extend the pot life thereof. The retarder may be in sufficient quantity to extend the pot life to a desired time, e.g. about 1 to about 24 hours, or about 1 to 12, 1 to 6, 6 to 24, 12 to 24, 6 to 12, 1 to 3, 3 to 5 or 2 to 4 hours, e.g. about 1, 2, 3, 4, 5, 6, 7, 8, 9, 10, 11, 12, 15, 18, 21 or 24 hours. It may be present in under 0.5% by weight, or under about 0.4, 0.3 or 0.2%, or at about 0.1 to about 0.5%, or 0.1 to 0.3, 0.3 to 0.5 or 0.2 to 0.4%, e.g. about 0.1, 0.2, 0.3, 0.4 or 0.5% by weight. The aqueous mixture (and cementitious composition) may comprise fumed silica. This can generally be used in low quantities, for example about 0.1 to about 1%, or about 0.1 to 0.5, 0.5 to 1 or 0.3 to 0.7%, e.g. about 0.1, 0.2, 0.3, 0.4, 0.5, 0.6, 0.7, 0.8, 0.9 or 1% by weight of the solids. It may be a hydrophilic fumed silica. It may be a hydrophobic fumed silica. It may be amorphous silica. This may function as a rheology modifier, e.g. as a thickener. It may confer suitable shear thinning rheology on the mixture, as discussed elsewhere. A suitable fumed silica is Wacker HDK® H15, which is a hydrophobic pyrogenic fumed silica of about 120 m²/g Rheology modifiers include clay (i.e. layered silicate) based rheology/flow modifiers. A suitable example is Optibent™ 616. This may be used in about 1 to 2% of the solids by weight or about 1 to 1.5, 1.5 to 2 or 1.3 to 1.7%, e.g. about 1, 1.1, 1.2, 1.3, 1.4, 1.5, 1.6, 1.7, 1.8, 1.9 or 2%. Another optional component is a the superplasticizer which allows cement mixtures to be sprayed at lower water contents, thus giving faster drying times and less shrinkage cracking. An example is RheoActiv® SP, a polycarboxylate ether super plasticizer (PESP). A further optional component is a defoamer, e.g a silicone antifoam or defoamer (such as Sifoam® SP15) to suppress bubble and void formation during high speed mixing. A suitable proportion of the defoamer is about 0.1 to about 1%, or about 0.1 to 0.5, 0.5 to 1 or 0.3 to 0.7%, e.g. about 0.1, 0.2, 0.3, 0.4, 0.5, 0.6, 0.7, 0.8, 0.9 or 1% by weight of the solids.
setting accelerator: aluminium sulphate or other similar material may be used as a setting accelerator in order to achieve cure of the aqueous coating mixture to form the cured cementitious composition in a suitably short time. Full cure in less than about 28 days is preferred, or in less than about 21 or 14 days, or in about 14 to 35 days, or 14 to 28 days, e.g. about 14, 21, 28 or 35 days. The amount of setting accelerator should be sufficient to achieve cure in the desired time. Rapid cure may be achieved by use of a high alumina cement.

The proportion of the combined pigment and UV absorber and setting accelerator (if present) in the cured cementitious coating, or in the solids of the aqueous coating mixture, may be less than about 2% by weight, or less than about 1.5 or 1%, or about 0.5 to 2, 0.5 to 1, 1 to 2 or 0.5 to 1.5%, e.g. about 0.5, 1, 1.5 or 2%. In some cases it may be greater than 2%, e.g. about 2.5 or 3% by weight.

A suitable composition for the aqueous coating mixture is: solids 75 wt % (EVA polymer 42.0%, cement 20.0%, sand (0.3-0.06 mm) 23.0%, calcium carbonate 10.3%, silica 0.5%, clay 1.5% and other fillers 2.70%) and water 25 wt %.

Another suitable composition for the aqueous coating mixture is:

44.1% Vinnapas® 7055N, which is a terpolymer powder of vinyl acetate, vinyl ester and ethylene. It is dispersible in water and has very good saponification resistance. The high ethylene content makes the resin soft and elastic, even at low temperatures;

1.5% Optibent® 616, which is an activated layer silicate rheology modifier for the composition which acts as a clay based rheology/flow modifier. It also acts as a self-leveling filling compound (SLF).

0.5% Sifoam SP 15, which is a silicone antifoam or defoamer to suppress bubble and void formation during high speed mixing;

13.4% calcium carbonate Omyacarb® 20 BG, which acts as a reinforcing filler;

about 10% cement,

0.5 wt. % HDK® H15 fumed silica, which is a synthetic, hydrophobic amorphous silica, produced via flame hydrolysis, which acts as a thickening and thixotropic agent and as a reinforcing filler and a free flow additive in the production of technical powders,

graded sand of the following types: 2× coarse sand 16-30 and 1× fine sand 600.

Once cured on the geotextile, the cured cementitious composition may provide a flexible and resilient layer on the geotextile. The composition may be water resistant. It may be waterproof. The components of the cured cementitious composition may be distributed substantially homogeneously through the cured composition. The polymer may be present therein as a continuous phase in which the other components are comprising the cement and fillers, or the cured cementitious composition may be present as a bicontinuous or co-continuous material in which a polymer phase and a cementitious phase interpenetrate. It may therefore be in the form of an interpenetrating network. The cured cementitious composition may be present as a layer on the geotextile. It may also penetrate at least partially into the geotextile—this may serve to improve adhesion of the composition to the textile by a physical “keying in” mechanism to provide mechanical anchoring. The layer may be at least about 2 mm thick, or at least about 2.5, 3, 3.5 or 4 mm thick, or about 2 to about 5 mm thick, or about 2 to 4, 2 to 3, 3 to 5 or 3 to 4 mm thick, e.g. about 2, 2.5, 3, 3.5, 4, 4.5 or 5 mm thick.

The geotextile may comprise, or may consist essentially of, a geofabric, a geogrid or some other structurally engineered composite. It may be a non-woven geotextile or it may be a woven geotextile. It may be at least partially porous to allow at least partial penetration of the aqueous mixture therein during formation of the membrane.

The components of the aqueous coating mixture have been described above. The aqueous coating mixture may have rheology, particularly viscosity, suitable for spraying. It may have suitable rheology such that the mixture at least partially penetrates the geotextile, so that the resulting cured cementitious coating at least partially penetrates the geotextile. The aqueous coating mixture may be shear thinning, so that it is sprayable and yet does not flow away from the geotextile once applied thereto. This may serve to prevent sag, slump and dripping. The aqueous coating mixture may be a slurry, or it may be a suspension, or it may be a dispersion, or it may be an emulsion, or it may be a latex. It may be more than one of these, e.g. the it may be a latex comprising polymer latex particles dispersed in an aqueous phase that has fillers and cement dispersed or suspended therein. It may be sprayable or it may be paintable, or both.

The aqueous coating mixture may have a solids content of about 60 to about 80% by weight, or about 60 to 70, 70 to 80 or 65 to 75%, e.g. about 60, 65, 70, 75 or 80% by weight. It may therefore have a water content of about 20 to 40% by weight, e.g. about 20, 25, 30, 35 or 40%.

Step (i) of the process may deposit a layer of the aqueous coating mixture on the geotextile. The layer may be at least about 2 mm thick or at least about 3 mm thick, or may be about 2 to about 5 mm thick, or about 2 to 4, 3 to 5 or 3 to 4 mm thick, e.g. about 2, 2.5, 3, 3.5, 4, 4.5 or 5 mm thick. The resulting layer of cured cementitious composition may be at least about 2 mm thick or at least about 3 mm thick, or may be about 2 to about 5 mm thick, or about 2 to 4, 3 to 5 or 3 to 4 mm thick, e.g. about 2, 2.5, 3, 3.5, 4, 4.5 or 5 mm thick.

The aqueous coating mixture may be stirred prior to application to the geofabric. The inventors have found that continuous stirring can retard setting so as to extend pot life of the mixture. It may extend the pot life to about 24 hours, even in the absence of a retarder.

Geotextiles are permeable fabrics which are commonly used in applications where they are in contact with soil. They may for example be used for reinforcing soil or for drainage purposes. Many geotextiles are made from polypropylene or polyester. They may be woven or non-woven. They may for example be needle punched or heat bonded. They may comprise a reinforcing agent, e.g. a fibreglass reinforcement. The fibreglass, if present, should be an alkaline tolerant fibreglass.

Related materials include geofabrics, geogrids, geonets and meshes. These are commonly referred to as geosynthetics and in the context of the present specification the term “geotextile” should be taken to encompass all of these.

The process may comprise the step of forming the aqueous coating mixture. As no chemical reactions occur when forming the mixture, they may in general be combined in any suitable order. It may be convenient to disperse the polymer in the water prior to addition of any of the other components, however in some methods it may be preferred to combine other components with the water prior to combining the resultant mixture with the polymer. In some embodiments the polymer is produced by emulsion polymerisation. In such cases it may be convenient to use the latex generated by the emulsion polymerisation directly, by combining it with the remaining components so as to form the aqueous coating mixture.

The membrane of the invention may be made by applying the aqueous coating mixture onto a geotextile, and allowing the coating mixture to set so as to form a cured cementitious composition in and/or on the geotextile. This may comprise hydration of the cement. It may comprise evaporation of at least part of the water of the aqueous mixture. It may comprise both of these processes.

The aqueous coating mixture may be applied to the geotextile by spraying or by painting or by rolling or by spreading or by any other suitable method. In some cases the geotextile may be located in a desired location (e.g. on the soil or surface of a water channel) and the coating mixture applied to the geotextile in situ. In this case, on drying of the aqueous coating mixture, the membrane is formed in situ. Alternatively the aqueous coating mixture may be applied to the geotextile and dried in a factory environment to form the membrane, and the membrane may subsequently be attached to a substrate (e.g. a water channel) to be waterproofed. The advantage of in situ membrane formation is that a lower weight of material (only the uncoated geotextile) needs to be applied to the substrate. Also application of the aqueous coating mixture and drying thereof to form the cured cementitious coating may serve to join different sheets of membrane together, thus avoiding a separate gluing or other bonding process. The advantage of factory fabrication of the membrane is the provision of more controlled conditions for formation of the membrane. Also the geotextile may be maintained horizontal and flat when applying the aqueous coating mixture, thereby facilitating a more uniform layer of cured cementitious composition on the geotextile. The two approaches may be combined in order to obtain many of the benefits of each. Thus the membrane may be preformed in a controlled factory environment, applied to a substrate (e.g. by laying in place and/or by bolting in place with batten strips or by some other method) and any joins, perforations due to bolting etc. may be sealed by used of a further application of the aqueous coating mixture. The aqueous coating mixture may be cured or set by leaving the geotextile with the aqueous coating mixture thereon at a suitable temperature for sufficient time in the open air. A sufficient time may be for example about 1 to about 24 hours, or about 1 to 12, 1 to 6, 1 to 3, 3 to 24, 6 to 24, 12 to 24, 3 to 6 or 6 to 12 hours, e.g. about 1, 2, 3, 4, 5, 6, 9, 12, 15, 18, 21 or 24 hours. A suitable temperature may be room temperature, or may be about 10 to about 30° C., or about 10 to 20, 20 to 30, 15 to 20, 20 to 25 or 15 to 25° C., e.g. about 10, 15, 20, 25 or 30° C. This may at least partially evaporate the water from the mixture and/or may hydrate the cement and optionally other components of the mixture so as to cure/set the cement.

The membrane may be used for waterproofing a surface. The surface may be the surface of a water channel. It may be the inner surface of a water storage vessel such as a water tank. It may be a roof of a dwelling or of some other building. It may be some other surface requiring waterproofing. The membrane may be laid on the surface to be waterproofed, or it may be fixed thereto e.g. by bolting with batten strips or screwing. In this case it may be necessary to waterproof the penetrations of the bolts or screws through the membrane, e.g. by application of further aqueous mixture, or by application of some other waterproofing material (e.g. a curable silicone composition). The geotextile may be laid on the surface or fixed thereto as described above, and the aqueous mixture may be applied thereto so as to form the membrane in situ.

Once installed on a surface, the membrane may be capable of resisting penetration of water there through to the surface. It may have sufficient strength and resilience to resist physical insults such as for example the hoofs of animals such as horses, cows, pigs or other farm animals without rupturing or compromising its waterproofing properties. It may be capable of being laid on an uneven e.g. stony or rocky surface without rupturing or compromising its waterproofing properties. It may be capable of resisting UV radiation, e.g. solar radiation or other radiation to which it exposed in use. The membrane may be capable of maintaining sufficient physical and waterproofing properties to perform its waterproofing task and to resist physical (including mechanical and optionally radiation) insults as described above for at least about 1 year, or at least about 2, 3, 4, 5, 6, 7, 8, 9 or 10 years, or about 1 to about 20 years, or about 5 to 20, 10 to 20 or 15 to 20 years, e.g. about 1, 2, 3, 4, 5, 6, 7, 8, 9, 10, 11, 12, 13, 14, 15, 16, 17, 18, 19 or 20 years. In some instances it may retain these properties for more than the above times, e.g. about 25, 30, 35, 40, 45 or 50 years. It may retain these properties even when exposed to UV radiation from the sun, i.e. it may be suitable for long term outdoor waterproofing applications. The membrane, in particular the binder polymer thereof, may be capable of retaining its strength and resilience and flexibility at elevated temperatures to which it may be exposed during use. The elevated temperatures may be due to outdoor exposure to the sun, or may be due to exposure to heated aqueous liquids. The elevated temperature may be anywhere from about 25 to about 100° C., depending on the application, or about 25 to 80, 25 to 60, 25 to 40, 40 to 100, 60 to 100, 30 to 90, 30 to 50 or 50 to 90° C., e.g. about 25, 30, 35, 40, 45, 50, 55, 60, 65, 70, 75, 80, 85, 90, 95 or 100° C., or at times even higher than 100° C. The membrane may be capable of withstanding these temperatures without substantial degradation and/or without becoming tacky. It may be capable of withstanding these temperatures for extended periods, depending on the particular application. In the event of outdoor exposure, it may be capable of withstanding these temperatures for periods of up to about 1 week, sometimes longer, or up to 6, 5, 4, 3, 2, 1 or 0.5 days. In cases where the aqueous liquid is a process liquid, the membrane may be capable of withstanding these temperatures for the lifetime of the membrane (typical lifetimes are listed above). The membrane may be capable of withstanding these temperatures while being exposed to UV radiation such as solar radiation, preferably without substantial degradation and/or without becoming tacky.

An example of an aqueous mixture according to the invention is as follows:
1. Water dispersible modified EVA polymer at 10-80 wt. %, more preferably 20-60 wt. % and most preferable 42 wt. %
2. Portland cement at 5-50% more preferably 10-30 wt. % and most preferable 20 wt. %
3. Sand (particle size 0.3-0.06 mm) at 5-50% more preferably 10-30 wt. % and most preferable 23 wt. %
4. Calcium carbonate** at 2-50% more preferably 5-20 wt. % and most preferable 10 wt. %
5. Sand and clay*** at 1-10% more preferably 2-5 wt. %
6. Other additives****(carbon black as a UV screener and aluminium sulphate as an setting accelerator) at less than 2 wt. %
7. Optionally retarders to extend the pot life (working time)
8. Water at about 35% by weight of the total of the above components.

### Notes:

*to increase the setting (drying) speed of the coating a high alumina cement can be advantageous used. High alumina cement according to British Standard 915 Part 2 i.e. a cement which contains not less than 32% by weight of alumina and has an alumina to calcium oxide ratio of between 0.85 and 1:3:1
**note calcium carbonate can replaced with highly acicular wollastonite or a swellable cellulosic fibre (e.g. Methocell) to give a more reinforced and resilient coating
***the sand and clay can be replaced with inorganic fillers from recycled sources such as recycled crushed glass or aluminium silicates. Elastomeric fillers such as ground tyre crumb can be added to impart additional flexibility and resilience.
****2.5 wt. % fine carbon black (max 25 nm particle size) is required to impart UV resistance and prevent UV degradation of the polymeric binder. Other stabilizers such as hindered amine light stabilizers (HALS) can be added to impart additional UV stability. The present invention describes a method for coating a geotextile substrates such as a non-woven geofabric comprises by spraying onto the surface a settable composition, comprising the cementitious composition and an aqueous emulsion of an organic polymer binder, and continuing the spraying to form a coating on the surface at least 3 mm in thickness and allowing the coating to set. It is believed that setting occurs by the water of the aqueous emulsion being used to hydrate the cement components. Evaporation of water from the mixture may enhance the setting.

The membrane of the present invention may be used as a waterproof liner in many applications. It may be used as a waterproof liner in applications in which the liner is exposed to mechanical challenges, e.g. traffic from humans, animals (e.g. cattle), vehicles (e.g. cars, trucks), falling objects (e.g. stones, rocks) or other mechanical challenges. It may be used for waterproofing structures that store or convey aqueous liquids. Such structures include storage tanks, pipes, channels etc. These may be used for storing and/or conveying water, e.g. potable water, waste water, rain water, storm run-off, drainage water, irrigation water, sewage, aqueous process streams, aqueous beverages etc. Suitable water storage structures include ponds, lagoons, impoundments, etc

1. A membrane comprising a geotextile and a flexible water impermeable cured cementitious composition disposed on at least one side of the geotextile, wherein said cured cementitious composition comprises:
a binder polymer;
cement;
a first filler; and
a second filler which is different to the first filler.

2. The membrane of claim 1 wherein the binder polymer is an ethylene-vinyl acetate copolymer.

3. The membrane of claim 2 wherein the ethylene-vinyl acetate copolymer comprises about 80 to about 90% by weight of vinyl acetate derived monomer units.

4.-5. (canceled)

6. The membrane of claim 1 wherein the first filler is a non-reinforcing filler.

7. The membrane of claim 6 wherein the non-reinforcing filler comprises sand having a mean particle size of about 0.06 to about 0.3 mm.

8.-9. (canceled)

10. The membrane of claim 1 wherein 0the second filler is a reinforcing filler.

11.-18. (canceled)

19. The membrane of claim 1 wherein the combined amount of pigment and UV absorber is less than about 2% by weight of the cured cementitious composition.

20. (canceled)

21. The membrane of claim 1 wherein the geotextile is selected from the group consisting of geofabrics, geogrids and other structurally engineered composites.

22. The membrane of claim 1 wherein the cured cementitious composition is present as a layer on and/or in the geotextile, said layer being at least about 2 mm thick.

23. (canceled)

24. The membrane of claim 1 wherein the geotextile is a composite geotextile comprising a woven/knitted geotextile attached to a non-woven geotextile.

25. The membrane of claim 24 wherein the cured cementitious composition is disposed on the woven/knitted geotextile, such that the non-woven geotextile is disposed on one side of the woven/knitted geotextile and the cementitious composition is disposed on another side of the woven/knitted geotextile.

26. The membrane of claim 24 wherein some fibres of the non-woven geotextile penetrate through the woven/knitted geotextile and into the cementitious composition.

27. A process for making a membrane, said process comprising:
(i) applying an aqueous coating mixture onto a geotextile; and
(ii) allowing the coating mixture to set so as to form a flexible cured cementitious composition in and/or on the geotextile;
wherein said aqueous coating mixture comprises:
a water dispersible polymer;
cement;
a first filler;
a second filler which is different to the first filler; and
water.

28. The process of claim 27 wherein the applying comprises spraying.

29.-34. (canceled)

35. The process of claim 27 wherein the aqueous coating mixture additionally comprises one or more of a pigment, a UV absorber and a setting accelerator, wherein the total weight of said pigment, UV absorber and setting accelerator is less than about 2% of the solids of the aqueous coating mixture.

36. The process of claim 27 wherein step (i) deposits a layer of the coating mixture on the geotextile that is at least about 2 mm thick.

37. The process of claim 27 wherein the geotextile and the aqueous coating mixture are such that the mixture at least partially penetrates the geotextile.

38. (canceled)

39. The process of claim 27 wherein the geotextile is a composite geotextile comprising a woven/knitted geotextile attached to a non-woven geotextile, said composite geotextile having a woven/knitted face and a non-woven face.

40. The process of claim 39 comprising the step of attaching the woven/knitted geotextile to the non-woven geotextile.

41. The process of claim 40 wherein the step of attaching comprises needle punching.

42. The process of claim 41 wherein the needle punching is from the non-woven geotextile into the woven/knitted geotextile.

43. The process of claim 39 wherein step (i) comprises applying the aqueous coating mixture onto the woven/knitted face of the composite geotextile.

44. The process of claim 27 comprising locating the geotextile in place before step (i).

45. The process of claim 27 wherein the aqueous coating mixture is such that it cures to form a waterproof cementitious composition in and/or on the geotextile.

46.-48. (canceled)

49. A method for waterproofing a surface, said method comprising securing a membrane according to claim 1 to said surface.

50. The method of claim 49 wherein the surface is the surface of a water channel or a lagoon or an impoundment or the inner surface of a water storage vessel.

51.-52. (canceled)
